(19) United States
(12) Patent Application Publication
(10) Pub. No.: US 2026/0302346 A1
(43) Pub. Date: Oct. 1, 2026

(54) SOLID ELECTROLYTE INCLUDING COVALENT ORGANIC FRAMEWORK, AND ALL-SOLID-STATE BATTERY INCLUDING SAME

(71) Applicant: UIF (UNIVERSITY INDUSTRY FOUNDATION), YONSEI UNIVERSITY, Seoul (KR)

(72) Inventors: Sang-Young LEE, Seoul (KR); Zhongping LI, Seoul (KR); Kyeong-Seok OH, Seoul (KR)

(73) Assignee: UIF (UNIVERSITY INDUSTRY FOUNDATION), YONSEI UNIVERSITY, Seoul (KR)

(21) Appl. No.: 19/476,077

(22) PCT Filed: Apr. 16, 2024
(86) PCT No.: PCT/KR2024/005065

§ 371 Date: Oct. 16, 2025

(30) Foreign Application Priority Data
Apr. 18, 2023 (KR) 10-2023-0050740

(51) Int. Cl. H01M 10/0565

(52) U.S. Cl. CPC H01M 10/0565; H01M 2300/0082

(57) ABSTRACT

The present invention relates to a solid electrolyte comprising a covalent organic framework, and more specifically, to a solid electrolyte comprising a covalent organic framework (COF) and a polyalkylene oxide-based crosslinked polymer, and an all-solid-state battery comprising the same.

### BACKGROUND

### 1. Field

The present invention relates to a solid electrolyte comprising a covalent organic framework, and an all-solid-state battery comprising the same.

### 2. Description of Related Art

Recently, as the development of lithium batteries with improved energy density and safety is required, all-solid-state batteries using solid electrolytes instead of liquid electrolytes are attracting attention as next-generation batteries.

Solid electrolytes can be classified into polymer solid electrolytes or inorganic solid electrolytes depending on their material, and in particular, inorganic solid electrolytes have the advantage of securing a high cation transport number and ionic conductivity. However, inorganic solid electrolytes have chemical instability, high interfacial resistance with electrodes, and require high temperature/high pressure conditions during cell manufacturing and driving processes, and particularly, there are difficulties in commercialization due to problems such as dendrite growth through voids in grain boundary defects, etc.

On the other hand, polymer solid electrolytes have superior advantages over inorganic solid electrolytes in terms of flexibility, light weight, processability, and chemical stability. However, polymer solid electrolytes have problems such as insufficient ionic conductivity and lithium ion yield at room temperature compared to conventional liquid electrolytes and inorganic solid electrolytes, and low electrochemical window, making combination with high-voltage cathode materials difficult.

Therefore, in order to solve the above problems, there is an urgent need for research on solid electrolytes with excellent chemical stability and outstanding ionic conductivity, and all-solid-state batteries comprising the same.

### SUMMARY

In order to solve the aforementioned problems, the present invention aims to provide a solid electrolyte with excellent chemical stability, ionic conductivity, and lithium ion yield.

Furthermore, another object of the present invention is to provide an all-solid-state battery comprising the solid electrolyte with excellent battery performance, cycle life characteristics, and rate capability.

In order to achieve the aforementioned tasks, the present inventors continuously researched to manufacture a solid electrolyte with excellent chemical stability and outstanding ionic conductivity, and as a result, they found that in the case of a solid electrolyte manufactured from a slurry composition mixing (i) a covalent organic framework comprising a specific repeating unit and (ii) a crosslinkable monomer selected from the group consisting of polyalkylene oxide-based polyfunctional monomers, 11-azido-3,6,9-trioxaundecan-1-amine, acrylonitrile, methacrylamide, and a combination of two or more thereof, it exhibits excellent ionic conductivity and lithium ion yield, and a battery comprising the same can achieve the effect of significantly improved cycle life characteristics and rate capability, thereby completing the present invention.

The present invention provides a solid electrolyte comprising: a covalent organic framework containing a repeating unit represented by the following Chemical Formula 1; and a crosslinked polymer derived from a crosslinkable monomer.

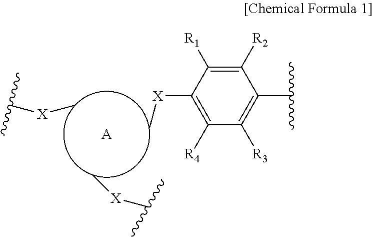

In Chemical Formula 1, A is a mono- or polycyclic ring compound, and —X— is a divalent linking group, and R¹ to R⁴ are independently selected from —H, —COOM, —SM, —SO₂M, —SO₃M, —PO₃M, or —PO₄M, where R¹ to R⁴ are not simultaneously —H, and M is Li, Li₂, or Li3.

According to one embodiment of the present invention, —X— in Chemical Formula 1 may be selected from the group consisting of a direct bond, —NH—, ═CH—NH—, —NH—C(═O)—, —CH═CH—NH—, —OC(═O)—NH—, —CH2-C(═O)O—NH—, —B(—O—)₂, and —C(═O)NH—N═CH—, and the like.

According to one embodiment of the present invention, Chemical Formula 1 may be represented by the following Chemical Formula 1-1.

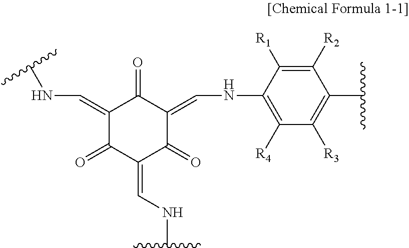

In Chemical Formula 1-1, R¹ to R⁴ are the same as defined in Chemical Formula 1.

According to one embodiment of the present invention, the covalent organic framework may be a polygonal structure having a repeating unit of Chemical Formula 1 on one side and a pore formed inside.

According to one embodiment of the present invention, the pores of the covalent organic framework may have a diameter of 1.0 to 8.0 nm.

According to one embodiment of the present invention, the covalent organic framework may include a repeating unit represented by the following Chemical Formula 2.

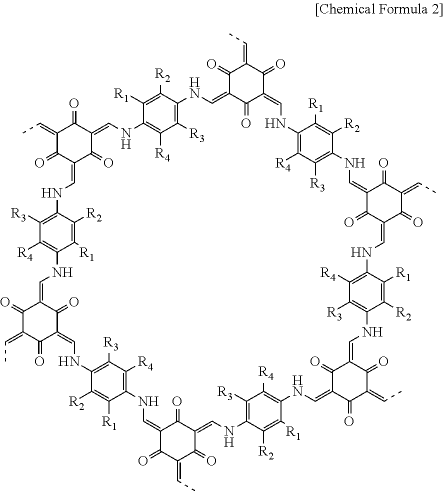

In Chemical Formula 2, R¹ to R⁴ are independently selected from —H, —COOM, —SM, —SO₂M, —SO₃M, —PO₃M, or —PO₄M, where R¹ to R⁴ are not simultaneously —H, and M is Li, Li₂, or Li₃.

According to one embodiment of the present invention, the crosslinkable monomer is selected from the group consisting of a polyalkylene oxide-based polyfunctional monomer, 11-azido-3,6,9-trioxaundecan-1-amine, acrylonitrile, methacrylamide, and a combination of two or more thereof.

According to a preferred embodiment, the crosslinkable monomer is a polyalkylene oxide-based polyfunctional monomer, and the use of the polyalkylene oxide-based polyfunctional monomer is preferable in that it facilitates the movement of lithium ions within the organic framework structure, thereby maximizing ionic conductivity.

The polyalkylene oxide-based polyfunctional monomer may include two or more reactive functional groups selected from the group consisting of an acrylate group, a methacrylate group, a vinyl group, a thiol group, an epoxy group, an isocyanate group, a silanol group, a halogen, a carboxyl group, a hydroxyl group, and an amine group.

According to one embodiment of the present invention, the polyalkylene oxide-based polyfunctional monomer may have a number average molecular weight of 100 to 10,000 g/mol.

According to one embodiment of the present invention, the crosslinked polymer may be included in an amount of 1 to 100 parts by weight based on 100 parts by weight of the covalent organic framework.

According to one embodiment of the present invention, the thickness of the solid electrolyte may be 0.1 to 100 μm.

According to one embodiment of the present invention, the lithium ion conductivity of the solid electrolyte may be 6.0×10⁻⁵ S/cm or more.

The present invention can provide an all-solid-state battery comprising the solid electrolyte described above.

The present invention can provide a method for manufacturing a solid electrolyte, comprising the steps of: (S1) applying pressure to a slurry composition for manufacturing a solid electrolyte, the composition comprising (i) a covalent organic framework containing a repeating unit represented by the following Chemical Formula 1 and (ii) a crosslinkable monomer selected from the group consisting of a polyalkylene oxide-based polyfunctional monomer, 11-azido-3,6,9-trioxaundecan-1-amine, acrylonitrile, methacrylamide, and a combination of two or more thereof; and (S2) manufacturing a crosslinked polymer by polymerizing the solid electrolyte slurry composition.

According to one embodiment of the present invention, in step (S1), a pressure of 5 to 250 MPa may be applied.

The present invention can provide a slurry composition for manufacturing a solid electrolyte, comprising (i) a covalent organic framework containing a repeating unit represented by the following Chemical Formula 1 and (ii) a crosslinkable monomer selected from the group consisting of a polyalkylene oxide-based polyfunctional monomer, 11-azido-3,6,9-trioxaundecan-1-amine, acrylonitrile, methacrylamide, and a combination of two or more thereof.

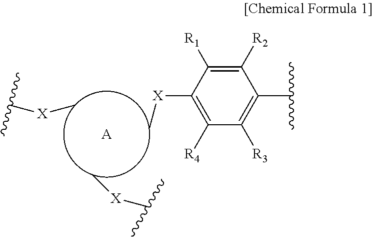

In Chemical Formula 1, A is a mono- or polycyclic ring compound, and —X— is a divalent linking group, and R¹ to R⁴ are independently selected from —H, —COOM, —SM, —SO₂M, —SO₃M, —PO₃M, or —PO₄M, where R¹ to R⁴ are not simultaneously —H, and M is Li, Li₂, or Li₃.

The all-solid-state battery employing the solid electrolyte according to one aspect of the present invention can simultaneously satisfy excellent battery performance, cycle life characteristics, and rate capability. Specifically, the solid electrolyte according to one aspect achieves high ionic conductivity and energy density at room temperature by the crosslinked polymer forming an interlayer lithium ion channel within the covalent organic framework structure, thereby inducing fast movement of lithium ions. Furthermore, it has excellent interfacial compatibility with electrodes, mechanical strength, and oxidation stability, as well as excellent interfacial stability with a lithium metal negative electrode, and superior processability, which is advantageous for commercialization.

### BRIEF DESCRIPTION OF THE DRAWINGS

FIG. 1 is Fourier Transform Infrared Spectroscopy (ATR-FT-IR) analysis spectra of COF-1 and COF-2 according to Preparation Examples 1 and 2.

FIG. 2 is X-ray diffraction analysis (XRD) spectra of COF-1 and COF-2 according to Preparation Examples 1 and 2.

FIG. 3 is a graph showing the results of the surface area analysis of COF-1 and COF-2 according to Preparation Examples 1 and 2.

FIG. 4 is a graph showing the results of the pore structure analysis of COF-1 and COF-2 according to Preparation Examples 1 and 2.

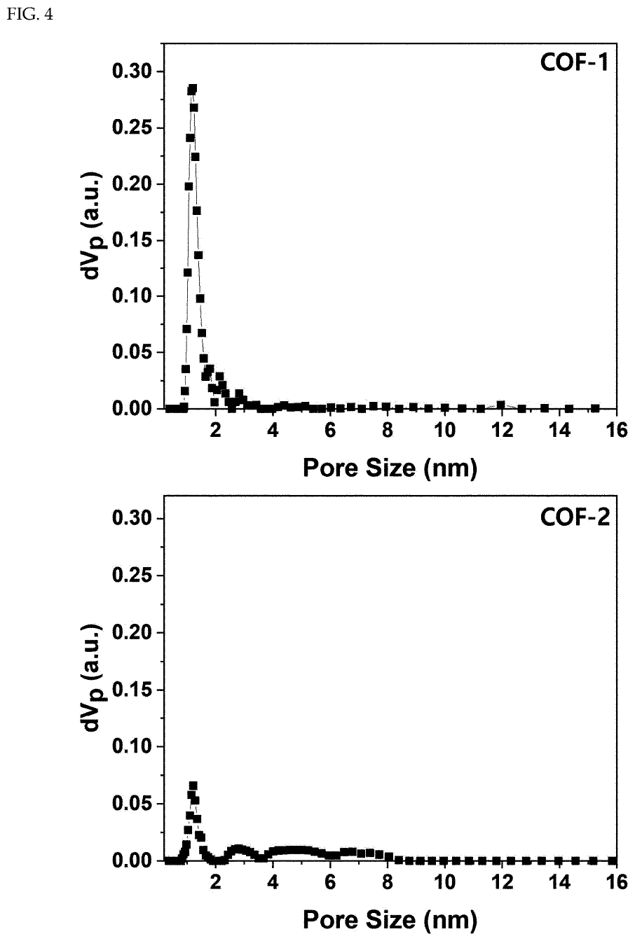

FIG. 5 is a schematic diagram briefly showing the method for manufacturing a solid electrolyte and the image of the manufactured solid electrolyte according to one embodiment.

Through this, it was confirmed that a solid electrolyte with excellent flexibility and potential for large area fabrication can be manufactured.

FIG. 6 is an SEM image analyzing the cross-section of the solid electrolyte according to Example 1.

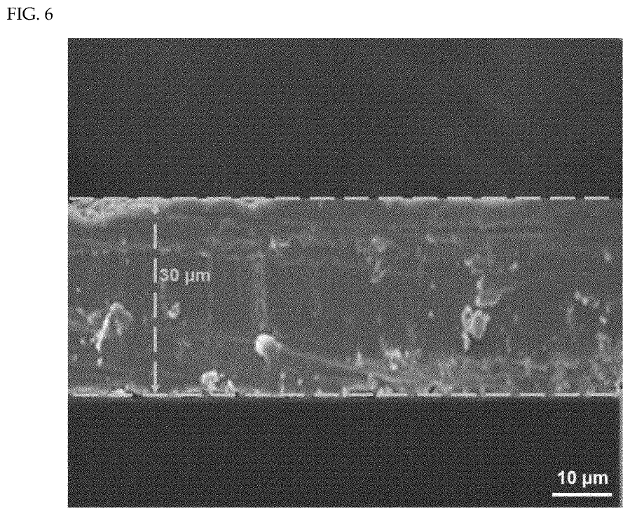

FIG. 7 is a graph showing the intercalation/deintercalation behavior over time to evaluate the stability between the lithium metal battery and the electrolyte according to Example 6 and Comparative Example 3.

FIG. 8 is a graph analyzing the electrochemical characteristics (charge/discharge voltage profile) of the all-solid-state lithium metal battery of Evaluation Example 4 comprising the solid electrolytes of Example 6 and Comparative Example 3. The descending curve in FIG. 8 represents the discharge capacity, and the ascending curve represents the charge capacity.

FIG. 9 is a graph showing the results of analyzing the cycle life characteristics (change in capacity and Coulombic efficiency according to the number of charge/discharge cycles) of the all-solid-state lithium metal battery of Evaluation Example 4 comprising the solid electrolytes of Example 6 and Comparative Example 3.

FIG. 10 is a graph showing the results of analyzing the rate capability (change in capacity according to the number of charge/discharge cycles per current density) of the all-solid-state lithium metal battery of Evaluation Example 4 comprising the solid electrolyte of Example 6.

### DETAILED DESCRIPTION

Unless defined otherwise herein, all technical and scientific terms have the same meaning as commonly understood by one of ordinary skill in the art to which this invention belongs. The terms used in the description herein are for the purpose of effectively describing specific embodiments only and are not intended to limit the invention.

The singular forms used herein may be intended to include plural forms as well, unless the context clearly indicates otherwise.

Furthermore, the numerical ranges used herein include the lower limit, the upper limit, and all values within the range, logically derived increments in the form and width of the defined range, all doubly limited values, and all possible combinations of the upper and lower limits of numerical ranges defined in different forms. Unless specifically defined otherwise herein, values outside the defined numerical range that may occur due to experimental error or rounding of values are also included in the defined numerical range.

The term “comprising,” as used herein, is an open-ended description having equivalent meaning to expressions such as “having,” “containing,” “possessing,” or “characterized by,” and does not exclude elements, materials, or processes not additionally listed.

In this specification, “substituted” may mean that one or more hydrogen atoms in the residue of the compound are substituted with a hydroxyl group, a nitro group, a cyano group, an amino group, a carboxyl group, a straight-chain or branched C₁ to C₆ alkyl group, a C₁ to C₆ alkylsilyl group, a C₃ to C₁₂ cycloalkyl group, a C₆ to C₁₂ aryl group, a C₂ to C₁₂ heteroaryl group, a C₁ to C₆ alkoxy group, a halogen group, or a C₁ to C₆ fluoroalkyl group, but is not particularly limited thereto.

Hereinafter, the solid electrolyte according to one embodiment of the present invention will be described in more detail.

One aspect of the present invention provides a solid electrolyte capable of realizing excellent ionic conductivity and electrochemical stability. Specifically, the present invention provides a solid electrolyte comprising: a covalent organic framework containing a repeating unit represented by the following Chemical Formula 1; and a crosslinked polymer derived from a polyalkylene oxide-based polyfunctional monomer.

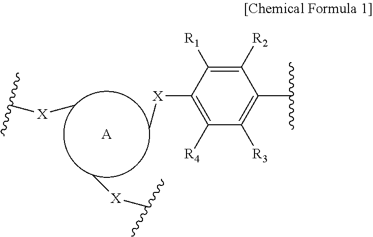

In Chemical Formula 1, A is a mono- or polycyclic ring compound, and —X— is a divalent linking group, and R¹ to R⁴ are independently selected from —H, —COOM, —SM, —SO₂M, —SO₃M, —PO₃M, or —PO₄M, where R¹ to R⁴ are not simultaneously —H, and M is Li, Li₂, or Li₃.

Specifically, in Chemical Formula 1, A may be a mono- or polycyclic aromatic or non-aromatic ring compound.

The monocyclic aromatic ring compound may be, for example, substituted or unsubstituted benzene, or an aromatic heterocyclic compound. However, the monocyclic aromatic ring compound of the present invention is not limited to the examples described above. As a non-limiting example, the monocyclic aromatic ring compound may be 1,3,5-triazine.

The polycyclic aromatic ring compound may be a substituted or unsubstituted polycyclic aromatic ring compound of C₃ to C₃₀, and may be, for example, substituted or unsubstituted bicyclic aromatic ring compounds of C₃ to C₃₀ such as naphthylene and azulene; tricyclic aromatic ring compounds such as anthracene, phenanthrene, and fluorene; tetracyclic aromatic ring compounds such as tetracene and pyrene; or a combination thereof, and may be a polycyclic aromatic ring compound derived therefrom, and may include one or more heterocyclic rings. However, the polycyclic aromatic ring compound of the present invention is not limited to the examples described above.

The monocyclic non-aromatic ring compound may be, for example, a substituted or unsubstituted C₃ to C₁₂ cycloalkane. However, the monocyclic non-aromatic ring compound of the present invention is not limited to the examples described above.

The polycyclic non-aromatic ring compound may be, for example, a polycyclic non-aromatic ring compound in which a plurality of monocyclic non-aromatic ring compounds are fused or unfused, but is not limited to the above example.

Further, A may be a compound in which a mono- or polycyclic aromatic ring compound and a mono- or polycyclic non-aromatic ring compound are fused or unfused. Preferably, it may be a monocyclic non-aromatic hetero ring compound of C₃ to C₅₀, or C₆ to C₂₀.

Here, the meaning of hetero means that the carbon of the ring compound is substituted with one or more heteroatoms selected from B, O, N, C(═O), P, P(═O), S, S(═O)2, and Si atoms.

According to one embodiment of the present invention, —X— in Chemical Formula 1 may be selected from the group consisting of a direct bond, —NH—, —CH—NH—, —NH—C(═O)—, —CH═CH—NH—, —OC(═O)—NH—, —CH2-C(═O)O—NH—, —B(—O—)₂, and —C(═O) NH—N═CH—, and the like, and preferably may be a direct bond, —CH—NH—, —NH—C(═O)—, or —CH═CH—NH—.

According to one embodiment of the present invention, R¹ to R⁴ in Chemical Formula 1 are independently selected from —H, —COOM, —SM, —SO₂M, —SO₃M, —PO₃M, or —PO₄M, where R¹ to R⁴ are not simultaneously —H, and M is Li, Li₂, or Li₃. Preferably, R¹ to R⁴ are independently selected from —H, —SO₃M, or —PO₃M, where R¹ to R⁴ are not simultaneously —H, and M may be Li, and in the case of a solid electrolyte satisfying this, more improved ionic conductivity and lithium ion yield can be realized.

According to one embodiment of the present invention, Chemical Formula 1 may be represented by the following Chemical Formula 1-1. The solid compound according to one embodiment may include a covalent organic framework (hereinafter, COF) containing at least one repeating unit selected from the repeating units represented by the following Chemical Formulas 1-1 to 1-4.

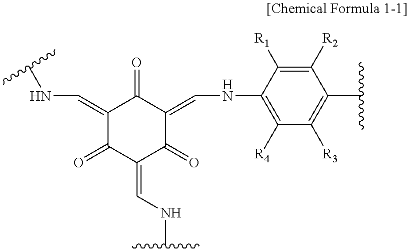

In Chemical Formula 1-1, R¹ to R⁴ are the same as defined in Chemical Formula 1.

According to another embodiment of the present invention, Chemical Formula 1 may be represented by the following Chemical Formula 1-2.

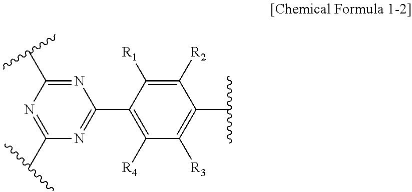

In Chemical Formula 1-2, R¹ to R⁴ are the same as defined in Chemical Formula 1.

According to another embodiment of the present invention, Chemical Formula 1 may be represented by the following Chemical Formula 1-3.

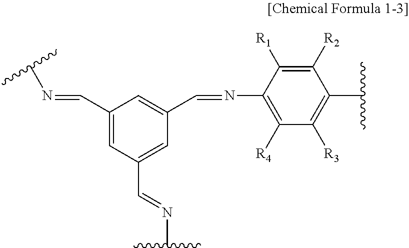

In Chemical Formula 1-3, R¹ to R⁴ are the same as defined in Chemical Formula 1.

According to another embodiment of the present invention, Chemical Formula 1 may be represented by the following Chemical Formula 1-3.

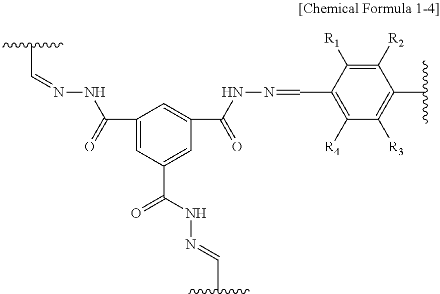

In Chemical Formula 1-4, R¹ to R⁴ are the same as defined in Chemical Formula 1.

According to one embodiment of the present invention, the covalent organic framework may be a polygonal structure having a repeating unit of Chemical Formula 1 on one side and a pore formed inside. The polygon may include, for example, regular or irregular triangles, squares, pentagons, hexagons, or combinations thereof, and is not particularly limited provided that a pore is provided inside. Specifically, the repeating unit of Chemical Formula 1 may be horizontally arranged to form a two-dimensional sheet layer, and may be a hexagonal structure with pores formed inside, and the pores may serve as a lithium ion channel between COF sheet layers. The solid electrolyte according to one embodiment has a low activation energy required for lithium ion dissociation for lithium ions to move between the sheet layers compared to conventional COFs, thereby realizing the effect of significantly improved faster ionic conductivity and lithium ion yield.

According to one embodiment of the present invention, the pores of the covalent organic framework may have an average diameter (pore size) of 0.1 to 20.0 nm, specifically 1.0 to 8.0 nm, specifically 1.0 to 2.0 nm, but are not limited thereto.

According to one embodiment of the present invention, the surface area of the covalent organic framework may be 10 to 800 mg²/g, specifically 50 to 500 mg²/g, but is not limited thereto.

According to one embodiment of the present invention, the covalent organic framework may include a repeating unit represented by the following Chemical Formula 2.

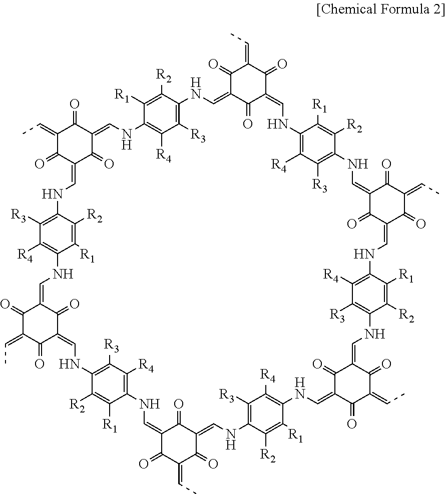

In Chemical Formula 2, R¹ to R⁴ are independently selected from —H, —COOM, —SM, —SO₂M, —SO₃M, —PO₃M, or —PO₄M, where R¹ to R⁴ are not simultaneously —H, and M is Li, Li₂, or Li₃, and detailed description thereof is the same as that of Chemical Formula 1 and thus omitted.

According to one embodiment of the present invention, the covalent organic framework may be in the form of a powder, and the average particle diameter thereof may be 0.001 to 10 μm, or 0.01 to 5 μm, but is not limited thereto.

According to one embodiment of the present invention, the polyalkylene oxide-based polyfunctional monomer may be a polyalkylene oxide-based polyfunctional monomer of C₁ to C₇, and specifically may be polyethylene oxide-based, polypropylene oxide-based, or polyethylene propylene oxide-based, but is not limited thereto.

According to one embodiment of the present invention, the polyalkylene oxide-based polyfunctional monomer may have a number average molecular weight of 20,000 g/mol or less, or 100 to 10,000 g/mol, or 300 to 1,000 g/mol.

According to one embodiment of the present invention, the polyalkylene oxide-based polyfunctional monomer may include two or more reactive functional groups selected from the group consisting of an acrylate group, a methacrylate group, a vinyl group, a thiol group, an epoxy group, an isocyanate group, a silanol group, a halogen, a carboxyl group, a hydroxyl group, and an amine group, and specifically may include the reactive functional groups described above at both termini. Preferably, the polyalkylene oxide-based polyfunctional monomer may include an acrylate group or/and a methacrylate group. Furthermore, when a polyalkylene oxide-based polyfunctional monomer is used rather than other types of functional monomers or polyfunctional monomers, it effectively forms an interlayer lithium ion channel within the covalent organic framework structure, thereby inducing faster movement of lithium ions, and thus realizing extremely excellent ionic conductivity and energy density.

Examples of polyalkylene oxide-based polyfunctional monomers including an acrylate group include diethylene glycol diacrylate, diethylene glycol dimethacrylate, ethylene glycol dimethacrylate, dipropylene glycol diacrylate, dipropylene glycol dimethacrylate, ethylene glycol divinyl ether, ethoxylated trimethylolpropane triacrylate, diethylene glycol divinyl ether, triethylene glycol dimethacrylate, tetraethylene glycol diacrylate, polyethylene glycol diacrylate (PEGDA) and polyethylene glycol dimethacrylate, and the like, and specifically, polyethylene glycol diacrylate (PEGDA), polyethylene glycol dimethacrylate, or a mixture thereof may be used, but is not limited thereto.

According to one embodiment of the present invention, the crosslinked polymer may be included in an amount of 1 to 100 parts by weight, specifically 5 to 50, or 5 to 40, specifically 10 to 25 parts by weight based on 100 parts by weight of the covalent organic framework. When the weight ratio is satisfied, a solid electrolyte having more improved ionic conductivity and lithium ion yield can be manufactured.

According to one embodiment of the present invention, the volume ratio of the covalent organic framework to the crosslinked polymer may satisfy 100:1 to 200, specifically 100:30 to 150, or 100:40 to 110, specifically 100:70 to 80. The crosslinked polymer may be formed by polymerization after the polyalkylene oxide-based polyfunctional monomer is filled inside the pores of the covalent organic framework during the manufacturing process. Accordingly, the solid electrolyte may have a structure comprising the covalent organic framework as a base material, and a member continuously filled with a three-dimensional crosslinked polymer structure inside the pores of the framework. Furthermore, the volume of the covalent organic framework herein may refer to the pore volume of the covalent organic framework. Moreover, the pore volume per unit weight of the covalent organic framework according to one embodiment may be 0.01 to 0.8 cm³/g, or 0.1 to 0.5 cm³/g, but is not limited thereto.

According to one embodiment of the present invention, the solid electrolyte may be formed into a film shape by a certain process, and has the advantage of being able to be manufactured as a free-standing film with excellent flexibility and potential for large area fabrication. In this case, the thickness of the solid electrolyte may be 0.1 to 100 μm or 1 to 50 μm, but can be easily adjusted depending on the field of application.

According to one embodiment of the present invention, since the solid electrolyte includes the covalent organic framework and the crosslinked polymer, it has superior flexibility compared to a solid electrolyte manufactured solely from the covalent organic framework, and has the advantage of being able to manufacture a large-area thin film.

According to one embodiment of the present invention, the ionic conductivity of the solid electrolyte, specifically the lithium ion conductivity, may exhibit excellent ionic conductivity of 3.0×10⁻⁵ S/cm or more, 6.0×10⁻⁵ S/cm or more, 8.0×10⁻⁵ S/cm or more, or 6.0×10⁻⁵ to 1.0×10⁻³ S/cm.

According to one embodiment of the present invention, the activation energy required for lithium ion dissociation in the solid electrolyte may be 0.2 eV or less, 0.01 to 0.17 eV, or 0.01 to 0.15 eV.

According to one embodiment of the present invention, the lithium ion yield of the solid electrolyte is 0.85 or more, or 0.9 or more, or 0.93 or more.

Hereinafter, one aspect of the present invention may provide a method for manufacturing the solid electrolyte manufacturing slurry composition described above.

The present invention can provide a slurry composition for manufacturing a solid electrolyte, comprising a covalent organic framework containing a repeating unit represented by the following Chemical Formula 1 and a polyalkylene oxide-based polyfunctional monomer.

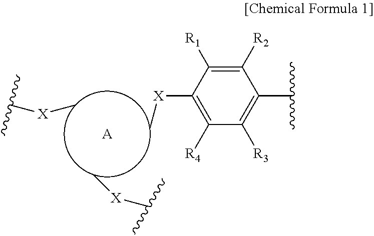

In Chemical Formula 1, A is a mono- or polycyclic ring compound, and —X— is a divalent linking group, and R¹ to R⁴ are independently selected from —H, —COOM, —SM, —SO₂M, —SO₃M, —PO₃M, or —PO₄M, where R¹ to R⁴ are not simultaneously —H, and M is Li, Li₂, or Li₃.

According to one embodiment of the present invention, in the slurry composition for manufacturing a solid electrolyte, the polyalkylene oxide-based polyfunctional monomer may be included in a weight ratio of 1 to 100, specifically 5 to 50, or 5 to 40, specifically 10 to 25 parts by weight based on 100 parts by weight of the covalent organic framework. Furthermore, the
volume ratio of the covalent organic framework to the polyalkylene oxide-based polyfunctional monomer may satisfy 100:1 to 200, specifically 100:30 to 150, or 100:40 to 110, specifically 100:70 to 80. Here, the volume of the covalent organic framework may refer to the pore volume of the covalent organic framework, and the pore volume of the covalent organic framework can be obtained by multiplying the pore volume per unit mass of the covalent organic framework by the weight of the covalent organic framework introduced.

The slurry composition for manufacturing a solid electrolyte may further include an initiator as necessary, and may further include a photoinitiator or a thermal initiator depending on the curing method. The initiator is not limited to known initiators, and examples of the photoinitiator may be selected from acetophenone-based compounds, benzophenone-based compounds, triazine-based compounds, benzoin-based compounds, imidazole-based compounds, xanthone-based compounds, phosphine-based compounds, and oxime-based compounds, but are not limited thereto. The examples of the thermal initiator may be selected from benzoyl peroxide (BPO), dicumyl peroxide (DCP), azobisisobutyronitrile (AIBN), and the like, but are not limited thereto.

Detailed descriptions of Chemical Formula 1, the polyalkylene oxide-based polyfunctional monomer, and the solid electrolyte are the same as described above, and thus omitted.

Hereinafter, one aspect of the present invention may provide the method for manufacturing a solid electrolyte described above.

The present invention can provide a method for manufacturing a solid electrolyte, comprising the steps of: (S1) applying pressure to a slurry composition for manufacturing a solid electrolyte, the composition comprising a covalent organic framework containing a repeating unit represented by the following Chemical Formula 1 and a polyalkylene oxide-based polyfunctional monomer; and (S2) manufacturing a crosslinked polymer by polymerizing the solid electrolyte slurry composition. Detailed descriptions of Chemical Formula 1, the polyalkylene oxide-based polyfunctional monomer, and the solid electrolyte are the same as described above, and thus omitted.

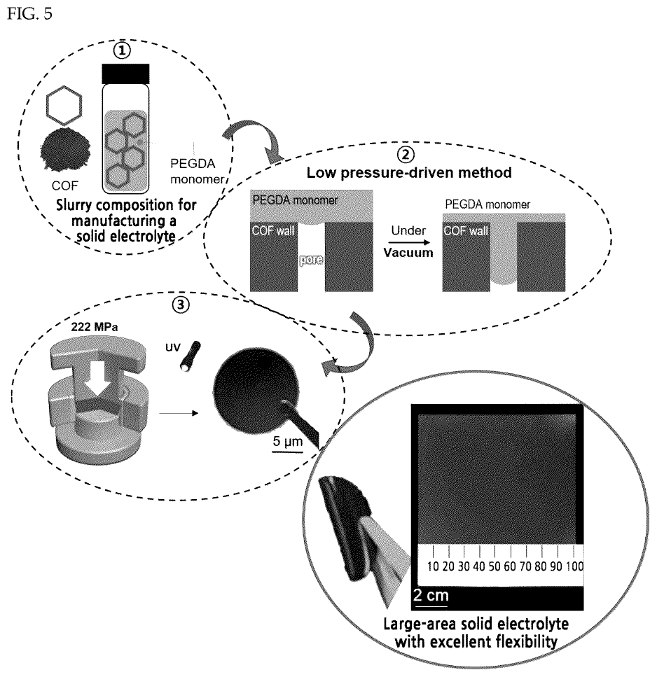

According to one embodiment of the present invention, in step (S1), a step of leaving the slurry composition for manufacturing a solid electrolyte under low pressure conditions for a certain time (Low pressure-driven method) may be further performed. Preferably, as shown in \textcircled{2} of FIG. 5, vacuum may be applied for 5 minutes or more, or 30 minutes or more, so that the liquid monomer can effectively penetrate into the pores of the covalent organic framework.

According to one embodiment of the present invention, in step (S1), a pressure of 1 to 400 MPa, 5 to 250 MPa, or 100 to 250 MPa may be applied, and methods generally used for applying pressure may be utilized.

According to one embodiment of the present invention, in step (S2), the solid electrolyte slurry composition is a curable composition, and the solid electrolyte may be manufactured through a curing (polymerization) reaction. The curing reaction may be performed by photocuring, thermal curing, or a combination thereof, and may be appropriately modified and performed depending on the purpose. Preferably, the polymerization may be a photocuring reaction, and may be a crosslinking polymerization by activating the aforementioned reactive functional groups by irradiating a light source in the ultraviolet wavelength range.

Furthermore, the slurry composition for manufacturing a solid electrolyte may further include an initiator or an organic solvent as necessary, but is not limited thereto.

Hereinafter, an all-solid-state battery according to one aspect will be described, but except for comprising the solid electrolyte according to one aspect, it can be manufactured in a structure known in the art using conventional manufacturing methods and materials in the art.

The present invention can provide an all-solid-state battery comprising the solid electrolyte described above. The all-solid-state battery includes a positive electrode layer and a negative electrode layer, and further includes a solid electrolyte layer between the positive electrode layer and the negative electrode layer, and the solid electrolyte layer may include the solid electrolyte according to one aspect.

According to one embodiment of the present invention, the positive electrode layer may include a positive electrode current collector and a positive electrode active material layer formed on the positive electrode current collector.

According to another embodiment of the present invention, the positive electrode active material layer is impregnated with the solid electrolyte according to one aspect in the pores, and the positive electrode layer and the solid electrolyte layer may be integrated with each other.

As an example, the thickness of the solid electrolyte layer may be 0.1 to 100 μm, 1 to 100 μm, or 5 to 50 μm, wherein the thickness of the solid electrolyte layer refers to the thickness of the section where the positive electrode active material layer and the solid electrolyte do not coexist and only the solid electrolyte according to one aspect exists.

The all-solid-state battery according to one aspect may be manufactured by including the steps of: (A) coating a positive electrode material slurry composition on one surface of a positive electrode current collector, followed by drying and rolling to manufacture a porous positive electrode active material layer; (B) impregnating the positive electrode active material layer with the solid electrolyte manufacturing slurry composition according to one aspect and polymerizing to manufacture a positive electrode layer impregnated with the solid electrolyte and a solid electrolyte layer integrated with the positive electrode layer; and (C) stacking the positive electrode layer impregnated with the solid electrolyte and a negative electrode layer.

Non-limiting examples of the positive electrode current collector may include foil manufactured from aluminum, nickel, or a combination thereof, and the positive electrode material slurry composition may include a solvent, and optionally a binder, conductive material, dispersant, etc., in the positive electrode active material. The thickness of the positive electrode current collector is not particularly limited, but may be 3 to 500 μm.

The positive electrode active material, if it is a material capable of reversible intercalation and deintercalation of lithium ions, can be used without limitation to conventional positive electrode active materials used in this technical field, and non-limiting examples include lithium cobalt oxide composite oxide (LiCoO₂), spinel type lithium manganese oxide composite oxide (LiMn₂O₄), lithium manganese oxide composite oxide (LiMnO₂), lithium nickel oxide composite oxide (LiNiO₂), lithium iron phosphate (LiFePO₄), lithium manganese phosphate (LiMnPO₄), lithium cobalt phosphate (LiCoPO₄), lithium iron pyrophosphate (LizFeP₂O₇), lithium niobium oxide composite oxide (LiNbO₂), lithium iron oxide composite oxide (LiFeO₂), lithium magnesium oxide composite oxide (LiMgO₂), lithium copper oxide composite oxide (LiCuO₂), lithium zinc oxide composite oxide (LiZnO2), lithium molybdenum oxide composite oxide (LiMoO₂), lithium tantalum oxide composite oxide (LiTaO₂), lithium tungsten oxide composite oxide (LiWO₂), lithium-rich nickel cobalt manganese composite oxide (xLi2MnO₃(1-x)LiMn_{1-y-z}Ni_{y}Co_{z}O₂), lithium nickel cobalt aluminum composite oxide (LiNi_{0.8}Co_{0.15}Al_{0.05}O₂), lithium nickel cobalt manganese composite oxide (LiNi_{0.33}Co_{0.33}Mn_{0.33}O₂, LiNi_{0.4}Co_{0.2}Mn_{0.4}O₂, LiNi_{0.5}Co_{0.2}Mn_{0.3}O₂, LiNi_{0.6}Co_{0.2}Mn_{0.2}O₂, LiNi_{0.7}Co_{0.15}Mn_{0.15}O₂, LiNi_{0.8}Co_{0.1}Mn_{0.1}O₂), nickel manganese oxide (LiNi_{0.5}Mn_{1.5}O₄), and the like, but is not limited thereto.

Examples of the conductive material include carbon black such as carbon black, acetylene black, Ketjen black, channel black, furnace black, lamp black, and thermal black; conductive fibers such as carbon fiber and metal fiber; metal powders such as carbon fluoride, aluminum, and nickel powder; conductive whiskers such as zinc oxide and potassium titanate; conductive metal oxides such as titanium oxide; and conductive materials such as polyphenylene derivatives, but are not particularly limited as long as they have conductivity without causing chemical changes in the battery.

The binder polymer may include one or more selected from the group consisting of nitrile butadiene rubber, polyethylene glycol, polyacrylonitrile, polyvinyl chloride, polymethyl methacrylate, polypropylene oxide, polydimethylsiloxane, polyvinylidene fluoride, polyvinylidene carbonate, and polyvinylpyrrolidinone, and preferably may be one or more selected from the group consisting of polyvinylidene fluoride, polyvinylidene carbonate, and polyethylene glycol, but is not limited thereto.

The negative electrode layer may include a negative electrode current collector and a negative electrode active material layer formed on the negative electrode current collector.

Non-limiting examples of the negative electrode current collector may be selected from foil manufactured from copper, gold, nickel, or a copper alloy, or a combination thereof. The negative electrode active material layer may be one or more selected from the group consisting of: carbon selected from soft carbon, hard carbon, artificial graphite, natural graphite, expanded graphite, carbon fiber, non-graphitizable carbon, carbon black, carbon nanotube, acetylene black, Ketjen black, graphene, fullerene, activated carbon, and meso carbon microbeads; a metal selected from silicon, tin, lithium, aluminum, silver, bismuth, indium, germanium, lead, platinum, titanium, zinc, manganese, cadmium, cerium, copper, cobalt, nickel, and iron; an alloy containing two or more of the metals; and an oxide of one or more of the metals, and preferably may be lithium metal, but is not limited thereto.

In particular, the solid electrolyte according to one aspect has excellent interfacial stability with a lithium metal negative electrode and effectively suppresses the dendrite growth phenomenon, thereby solving the limitations of conventional solid electrolytes, and can realize excellent cycle life characteristics and rate capability. Furthermore, the solid electrolyte has the advantage of operating with excellent performance even without the addition of additional lithium salt and solvent, by having a lithium ion channel formed by the combination of the covalent organic framework and the crosslinked polymer.

Hereinafter, embodiments of the present invention will be described in detail with reference to the attached drawings. However, these are provided so that those skilled in the art to which the present invention belongs can easily carry it out, and the present invention can be implemented in various different forms, and the scope of the present invention is not necessarily limited to the embodiments.

### [Preparation Example 1] Manufacturing of Covalent Organic Framework (COF-1, TpPa-SO₃Li)

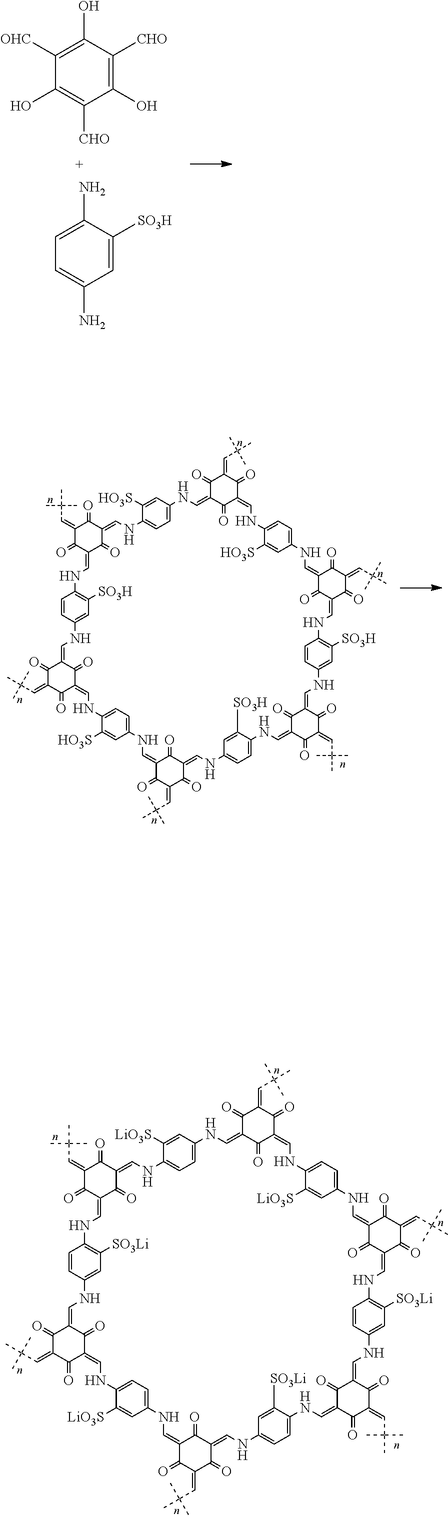

2,4,6-triformylphloroglucinol (63 mg, 0.3 mmol), 2,5-diaminobenzenesulfonic acid (84.7 mg, 0.45 mmol), 1,4-dioxane (1.2 mL, 14.1 mmol), 1,3,5-trimethylbenzene (0.8 mL, 5.75 mmol), acetic acid (0.216 mL, 3.6 mmol) and deionized water (0.38 g, 2.1 mmol) were charged into a Pyrex tube, and the mixture was flash-frozen in liquid nitrogen and the freeze-pump-thaw cycle was repeated three times to remove gas. The tube was then sealed and reacted at 120° C. for 3 days, and the precipitate was filtered and collected, washed with dimethylacetamide and acetone, and extracted via Soxhlet with tetrahydrofuran for 12 hours, then dried under vacuum at 120° C. overnight to obtain TpPa-SO₃H (Yield: 119.7 mg, 91%).

The synthesized TpPa-SO₃H (200 mg) was charged into a lithium acetate solution (5 M, 20 mL) and stirred for 3 days at room temperature, and the generated powder was filtered and washed 3 times, then dried under vacuum at 120° C. overnight to finally obtain TpPa-SO₃Li powder (hereinafter, COF-1) according to Preparation Example 1 (Yield: 173.5 mg, 85%).

### [Preparation Example 2] Manufacturing of Covalent Organic Framework (COF-2, TpPa-(SO₃Li) 2)

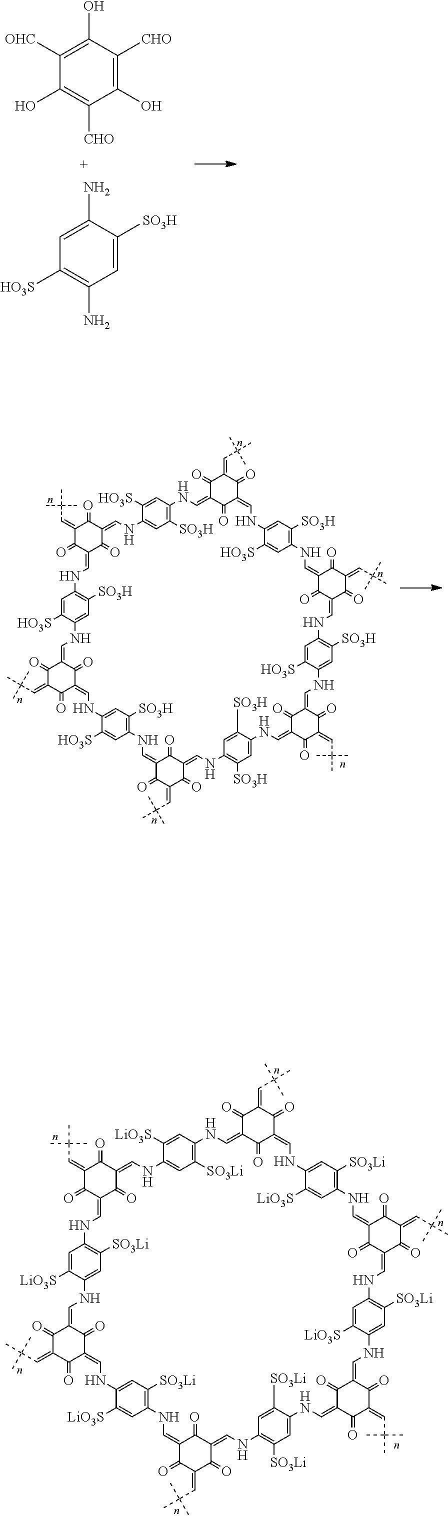

Preparation Example 2 was performed in the same manner as Preparation Example 1, except that 120.6 mg (0.45 mmol) of 2,5-diamino-1,4-benzenedisulfonic acid was charged instead of 2,5-diaminobenzenesulfonic acid in Preparation Example 1, and 40 mL of lithium acetate solution (5 M) was charged, and finally, TpPa-(SO₃Li) 2 powder (hereinafter, COF-2) according to Preparation Example 2 was obtained (Yield: 169.2 mg, 82%).

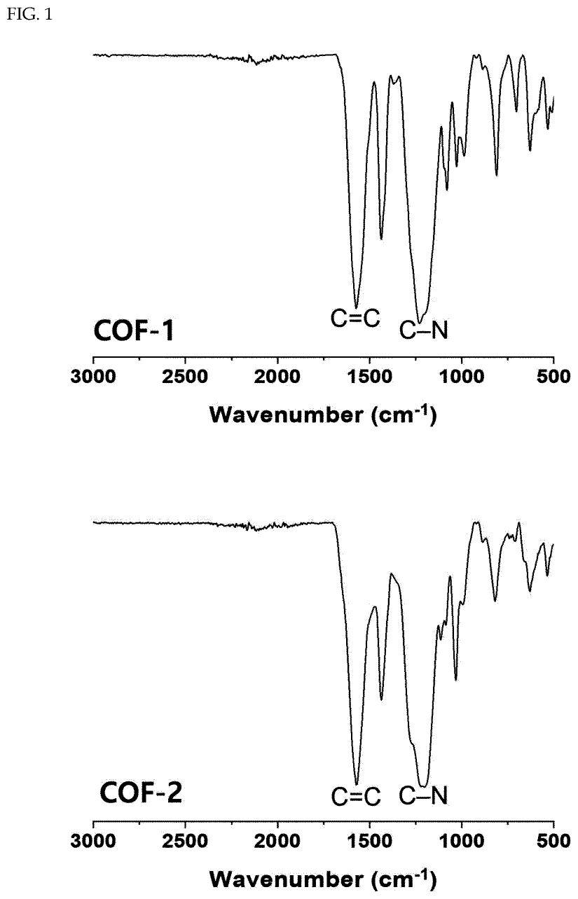

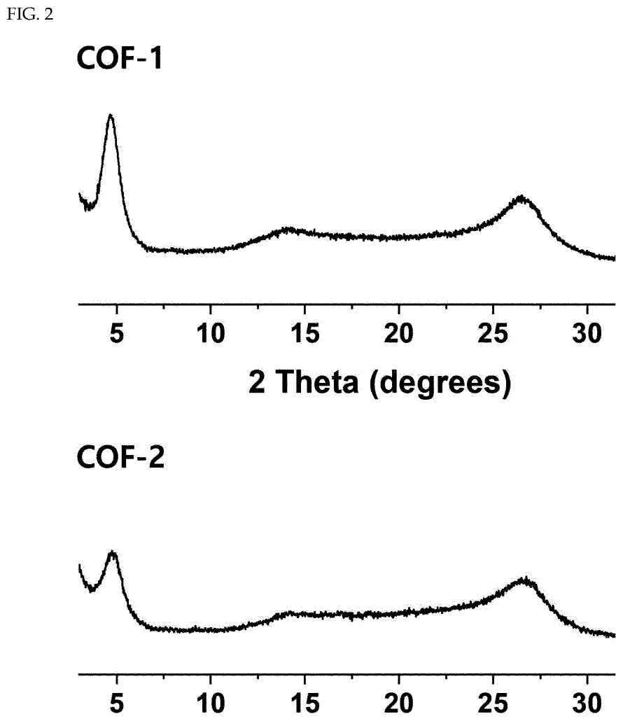

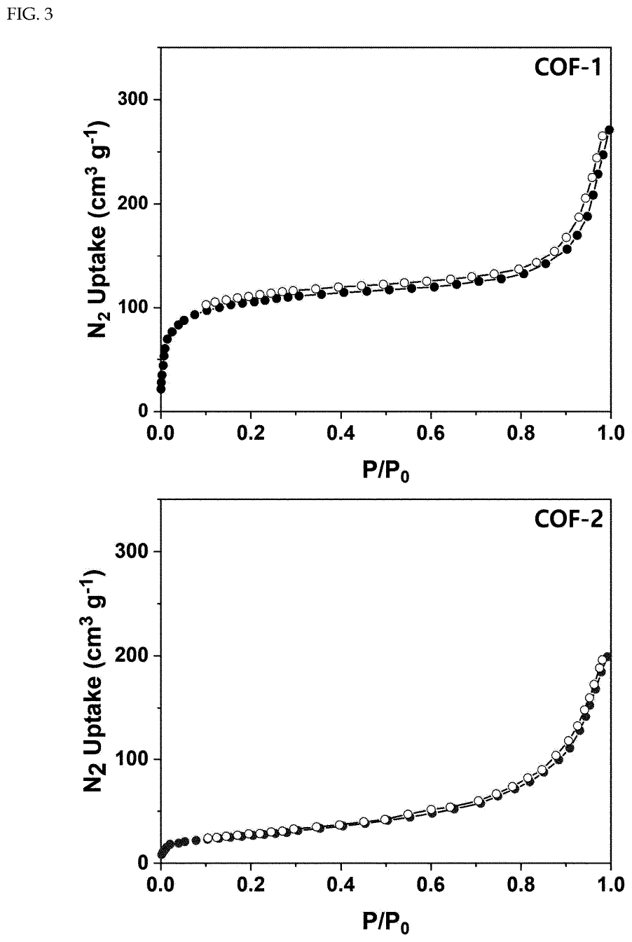

Fourier Transform Infrared Spectroscopy (ATR-FT-IR, Nicolet iS10 FTIR Spectrometer), X-ray diffraction analysis (XRD, X-ray diffraction, using a Kratos Amicus spectrometer equipped with a Ka X-ray source), and surface area/pore structure analysis (ASAP 242 from Micromeritics) were performed on the covalent organic frameworks according to Preparation Examples 1 and 2, and the results are shown in FIGS. 1, 2, and 3. Specifically, the surface area was measured to be 343 mg²/g for COF-1 and 95 mg²/g for COF-2, and the pore size was measured to be 1.2 nm for both COF-1 and COF-2.

### [Preparation Example 3] Manufacturing of Covalent Organic Framework (COF-3, TpPa-COOLi)

TpPa-COOH and TpPa-COOLi powder (hereinafter, COF-3) were obtained in the same manner as Preparation Example 1, except that 2,5-diaminobenzoic acid having the following structure was used instead of 2,5-diaminobenzenesulfonic acid (Yields: 90% and 86%, respectively).

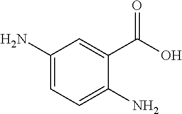 [SMILES: Nc1ccc(N)c(C(=O)O)c1]

### [Preparation Example 4] Manufacturing of Covalent Organic Framework (COF-4, TpPa-(COOLi) 2)

TpPa-(COOLi) 2 powder (hereinafter, COF-4) was obtained in the same manner as Preparation Example 2, except that 2,5-diamino-1,4-benzenedicarboxylic acid having the following structure was used instead of 2,5-diamino-1,4-benzenedisulfonic acid (Yield: 83%).

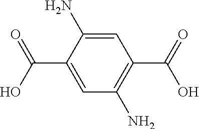 [SMILES: Nc1cc(C(=O)O)c(N)cc1C(=O)O]

### Example 1

The slurry composition for manufacturing a solid electrolyte according to Example 1 was prepared by charging COF-1 of Preparation Example 1, which is a covalent organic framework (COF), and PEGDA (Poly(ethylene glycol) diacrylate, Mn: 545 g/mol), which is a polyalkylene oxide-based polyfunctional monomer, in a weight ratio of 100:15, and applying vacuum for 2 hours. At this time, 1 part by weight of a photoinitiator was added based on 100 parts by weight of the PEGDA.

For property evaluation, the slurry composition for manufacturing a solid electrolyte was subjected to pressure of 222 MPa (3 ton) at 120° C. for 1 hour using a hydraulic press (Hefei Kejing Materials Technology Co., Ltd.) to form a film. A UV lamp of 365 nm was irradiated onto the film for 1 minute to finally manufacture a solid electrolyte in the form of a thin film of about 30 μm.

### Example 2

A thin film solid electrolyte was obtained by performing the same procedure as in Example 1, except that a solid electrolyte manufacturing slurry composition comprising COF-1 and PEGDA in a weight ratio of 100:24 was used.

### Example 3

A thin film solid electrolyte was obtained by performing the same procedure as in Example 1, except that a solid electrolyte manufacturing slurry composition comprising COF-1 and PEGDA in a weight ratio of 100:32 was used.

### Example 4

A thin film solid electrolyte was obtained by performing the same procedure as in Example 1, except that a solid electrolyte manufacturing slurry composition comprising COF-1 and PEGDA in a weight ratio of 100:40 was used.

### Example 5

A thin film solid electrolyte was obtained by performing the same procedure as in Example 1, except that COF-2 of Preparation Example 2 instead of COF-1 was used.

### Example 6

A thin film solid electrolyte was obtained by performing the same procedure as in Example 5, except that a solid electrolyte manufacturing slurry composition comprising COF-2 and PEGDA in a weight ratio of 100:11 was used.

### Example 7

A thin film solid electrolyte was obtained by performing the same procedure as in Example 5, except that a solid electrolyte manufacturing slurry composition comprising COF-2 and PEGDA in a weight ratio of 100:16 was used.

### Example 8

A thin film solid electrolyte was obtained by performing the same procedure as in Example 5, except that a solid electrolyte manufacturing slurry composition comprising COF-2 and PEGDA in a weight ratio of 100:21 was used.

### Example 9

A thin film solid electrolyte was obtained by performing the same procedure as in Example 1, except that COF-3 (TpPa-COOLi) of Preparation Example 3 was used instead of COF-1 (TpPa-SO₃Li) of Preparation Example 1.

### Example 10

A thin film solid electrolyte was obtained by performing the same procedure as in Example 1, except that 11-azido-3,6,9-trioxaundecan-1-amine was used instead of PEGDA.

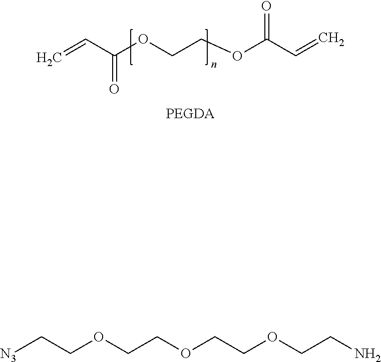

11-azido-3,6,9-trioxaundecan-1-amine

### Example 11

A thin film solid electrolyte was obtained by performing the same procedure as in Example 1, except that acrylonitrile having the following structure was used instead of PEGDA.

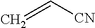

### Example 12

A thin film solid electrolyte was obtained by performing the same procedure as in Example 1, except that methacrylamide having the following structure was used instead of PEGDA.

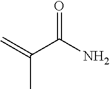

### Comparative Example 1

A solid electrolyte in the form of a thin film of about 250 μm was manufactured by applying a pressure of 222 MPa (3 ton) at 120° C. for 0.5 hours using a hydraulic press (Hefei Kejing Materials Technology Co., Ltd.) to COF-1 of Preparation Example 1, which is a covalent organic framework, alone.

However, attempts were made to manufacture a thin film of 30 μm, similar to the Examples, but COF-1 powder alone lacked flexibility and easily broke during the transfer step, making it difficult to manufacture a free-standing film. Therefore, a thin film of COF-1 alone was formed on a substrate using a stainless steel foil as a substrate or utilizing a pellet-type cell.

### Comparative Example 2

The procedure was performed in the same manner as in Comparative Example 1, except that COF-2 of Preparation Example 2 was used instead of COF-1.

Furthermore, for the solid electrolytes manufactured according to Examples 1 to 8 and Comparative Examples 1 and 2, the parts by weight of PEGDA based on 100 parts by weight of COF are listed in Table 1 below.

### [Evaluation Example 1] Ionic Conductivity (OLi)

Ionic conductivity measurement cells were manufactured by overlapping the solid electrolytes manufactured in the Examples and Comparative Examples between two identical stainless steel foils, and the ionic conductivity of the solid electrolytes was measured. Based on EIS (Electrochemical Impedance Spectroscopy) analysis, impedance was measured by applying an AC amplitude of 10 mV and a frequency range of 0.1 mHz to 5 MHz at room temperature, and the ionic conductivity was calculated according to the following Equation 1. The results are listed in Table 1 below.

$${σ}_{Li} = \frac{l}{RS} \qquad [ Equation 1 ]$$

(In Equation 1, 1 is the thickness of the all-solid-state battery, R is the resistance measured through EIS analysis, and S is the working area of the electrode.)

### [Evaluation Example 2] Lithium Ion Mobility

The activation energy (Eₐ) required to dissociate and move Li ions in each solid electrolyte was measured to evaluate the lithium ion mobility of the solid electrolytes manufactured in the Examples and Comparative Examples, and the results are shown in Table 1 below.

Furthermore, lithium ion yield measurement cells were manufactured by overlapping the solid electrolytes manufactured in the Examples and Comparative Examples between two identical lithium metal foils, and a DC voltage of 10 mV was applied at room temperature for 4 hours, and the impedance values before and after applying the DC voltage were measured to calculate the lithium ion yield (Li-ion transform number, t_{Li+}) according to the following Equation 2. The results are listed in Table 1 below.

$${t}_{{Li}^{+}} = \frac{{I}_{ss} ( Δ V - {I}_{0} {R}_{0} )}{{I}_{0} ( Δ V - {I}_{ss} {R}_{ss} )} \qquad [ Equation 2 ]$$

(In Equation 2, ΔV represents the polarization voltage, Iₛₛ and Rₛₛ represent the steady-state current and resistance values after polarization, and I₀ and R0 are the initial current and resistance values.)

TABLE 1

| | PEGDA | Ionic | | |
|---|---|---|---|---|
| | (parts by | Conductivity | Activation | Lithium Ion |
| | weight) | (RT) [S/cm] | Energy [eV] | Yield (t_{Li+}) |
| Example 1 | 15 | 3.8 × 10⁻⁵ | 0.16 | 0.92 |
| Example 2 | 24 | 4.7 × 10⁻⁵ | 0.15 | 0.93 |
| Example 3 | 32 | 2.1 × 10⁻⁵ | 0.19 | 0.91 |
| Example 4 | 40 | 1.6 × 10⁻⁵ | 0.19 | 0.91 |
| Example 5 | 11 | 7.3 × 10⁻⁵ | 0.13 | 0.93 |
| Example 6 | 16 | 8.5 × 10⁻⁵ | 0.11 | 0.95 |
| Example 7 | 21 | 5.3 × 10⁻⁵ | 0.15 | 0.92 |
| Example 8 | 26.6 | 4.7 × 10⁻⁵ | 0.17 | 0.91 |
| Example 9 | 15 | 1.8 × 10⁻⁵ | 0.17 | 0.93 |
| Example 10 | 15 | 2.7 × 10⁻⁵ | 0.16 | 0.91 |
| Example 11 | 15 | 3.1 × 10⁻⁵ | 0.15 | 0.90 |
| Example 12 | 15 | 2.6 × 10⁻⁵ | 0.16 | 0.92 |
| Comp. Ex. 1 | 0 | 2.5 × 10⁻⁵ | 0.18 | 0.90 |
| Comp. Ex. 2 | 0 | 4.5 × 10⁻⁵ | 0.16 | 0.92 |

As shown in Table 1, it was confirmed that the solid electrolytes of the Examples have significantly improved ionic conductivity and lithium ion yield compared to the solid electrolytes of the Comparative Examples.

Furthermore, the solid electrolyte according to one embodiment forms an ion channel through π-π* interaction, thereby significantly lowering the activation energy required to dissociate Li ions, which can induce fast movement of lithium ions within the positive electrode, and thus, a battery comprising the same can achieve excellent energy density.

Furthermore, the measurement of the ionic conductance (1/resistance) of Example 6 and Comparative Example 1 showed that Example 6 exhibited 38.8 mS and Comparative Example 1 exhibited 1.3 mS, confirming that the solid electrolyte according to one embodiment can be manufactured as a thin film and exhibits excellent ionic conductivity.

-Manufacturing of all-Solid-State Lithium Metal Battery

A positive electrode material slurry composition was manufactured by adding positive electrode active material (Me₂BBQ)/conductive material (carbon black; Super P)/binder (polyvinylidene fluoride, PVDF) in a weight ratio of 3/6/1 to N-methylpyrrolidone so that the content of the positive electrode material was 40 wt %. The positive electrode material slurry composition was coated onto an aluminum (Al) thin film having a thickness of 18 μm using a doctor blade, dried by hot air at 80° C., then vacuum dried at 120° C. for 24 hours to form a positive electrode active material layer having a thickness of 20 μm, thereby manufacturing a positive electrode layer.

Thereafter, the solid electrolyte manufacturing slurry composition of Example 6 was impregnated into the positive electrode active material layer, and pressure of 222 MPa (3 ton) was applied at 120° C. for 0.5 hours using a hydraulic press (Hefei Kejing Materials Technology Co., Ltd.) to form a film. A UV lamp of 365 nm was irradiated onto the film for 1 minute to manufacture a positive electrode layer impregnated with the solid electrolyte and a solid electrolyte layer integrated with the positive electrode layer, having a thickness of 30 μm.

Thereafter, an all-solid-state lithium metal battery according to Example 6 was manufactured by stacking a negative electrode layer, where a 50 μm thick lithium metal was rolled onto a 9 μm thick copper foil current collector.

### [Comparative Example 3] Manufacturing of Liquid Electrolyte Lithium Metal Battery

A lithium metal battery was manufactured by interposing a polyethylene-based porous polymer separator between the positive electrode layer and the negative electrode layer, without manufacturing a solid electrolyte layer in the method for manufacturing the all-solid-state lithium metal battery described above, and injecting an electrolyte solution in which 1M LiTFSI was dissolved in a solvent mixed with dimethyl ether (DME) and 1,3-dioxolane (DOL) at a volume ratio of 1:1.

### [Evaluation Example 3] Battery Stability Evaluation

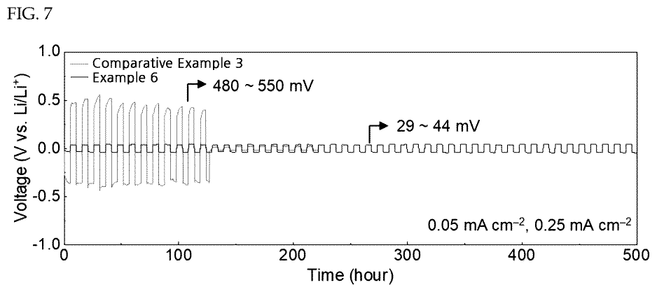

To evaluate the stability of the solid electrolyte against the lithium metal negative electrode, the intercalation/deintercalation behavior of lithium metal in the lithium metal batteries according to Example 6 and Comparative Example 3 was confirmed. Specifically, current was applied to the lithium metal battery at a current density of 0.05 mA/cm² for 5 hours to charge/discharge an area capacity of 0.25 mAh/cm², and the voltage change was observed during a total of 50 intercalation/deintercalation cycles for 500 hours, and the results are shown in FIG. 7.

Referring to FIG. 7, it was confirmed that Example 6 forms a significantly lower overpotential compared to Comparative Example 3, and through this, it was confirmed that when the solid electrolyte according to one embodiment is used, a battery with excellent stability with a lithium metal negative electrode can be manufactured by effectively controlling the formation of lithium metal and dendrites.

### [Evaluation Example 4] Cycle Life Characteristics Evaluation

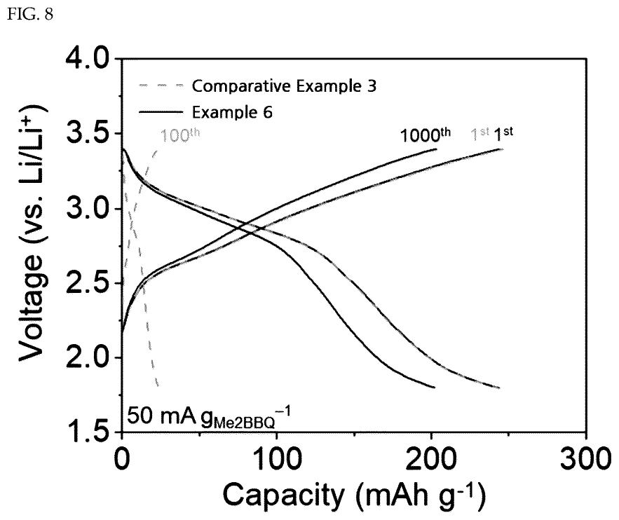

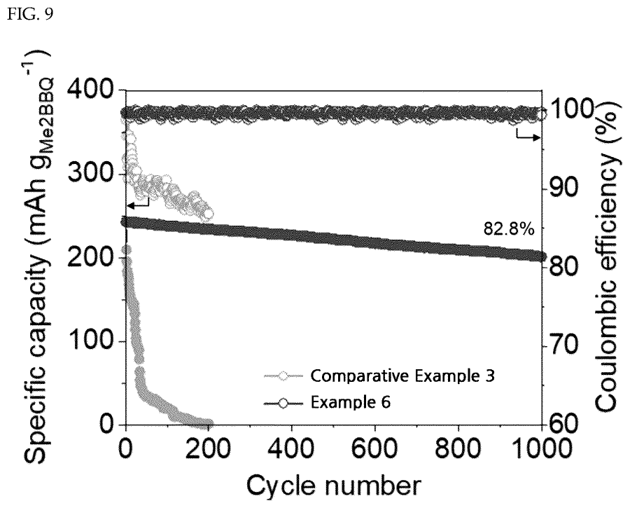

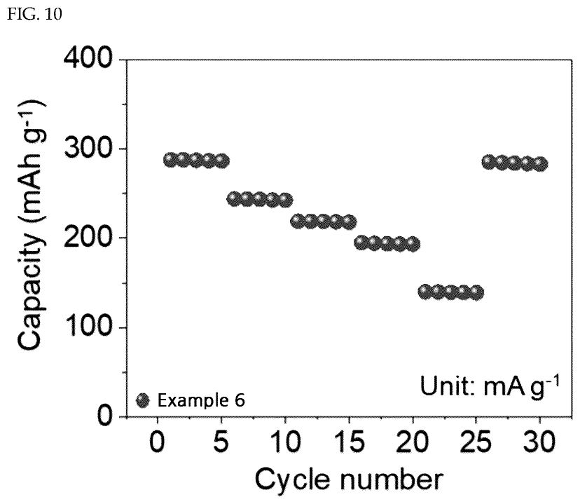

The room temperature cycle life characteristics and rate capability of the lithium metal batteries manufactured in Example 6 and Comparative Example 3 described above were analyzed. The charge/discharge conditions were a 1000-cycle life test conducted at room temperature (25° C.) at a current density of 50 mA/g within a voltage range of 1.8 to 3.4 V, and the results are shown in FIGS. 8 and 9. Furthermore, to measure the rate capability, several cycle tests were performed by changing the current density to 20, 50, 100, 200, and 500 mA/g within a voltage range of 1.8 to 3.4 V, and the results are shown in FIG. 10.

Referring to FIGS. 8 to 10, the all-solid-state lithium metal battery applying the solid electrolyte of Example 6 exhibits excellent performance compared to the battery applying a liquid electrolyte, and specifically, it can be seen that it achieves an excellent capacity retention rate of 80% or more even after 1000 cycles. In the case of Comparative Example 3, the organic electrode, more than 50 wt %, is dissolved by the liquid electrolyte after 100 cycles, causing a problem where it can no longer function as an active material, thus exhibiting very poor cycle life characteristics. In contrast, in the case of Example 6, the electrode does not dissolve even after 200 cycles, and accordingly, the solid electrolyte has high ionic conductivity operable at room temperature and low activation energy required for the movement of lithium ions, enabling fast ion movement, and exhibits excellent interfacial stability with high-capacity positive electrode materials such as Me₂BBQ or the lithium metal negative electrode, resulting in excellent cycle life characteristics and rate capability.

Furthermore, when the solid electrolyte according to one embodiment is used, various functional groups can be attached to achieve the desired properties, allowing for wide use in various battery systems. Additionally, the solid electrolyte according to one embodiment has a low density, thus exhibiting significantly high capacity relative to weight, and enabling easy realization of improved energy density, and accordingly, it can be utilized in various fields where high energy density is required, such as electric vehicles, drones, and airplanes.

As described above, the present invention has been described by limited embodiments, but this is provided only to help a more comprehensive understanding of the present invention, and the present invention is not limited to the above embodiments, and various modifications and variations are possible from this description by those skilled in the art to which the present invention pertains.

Therefore, the spirit of the present invention should not be limited by the described embodiments, and all things that are equivalent or equivalent variations of the claims described below, as well as the claims themselves, shall be included in the scope of the spirit of the present invention.

We claim:

1. A solid electrolyte comprising: a covalent organic framework containing a repeating unit represented by the following Chemical Formula 1; and a crosslinked polymer derived from a crosslinkable monomer. 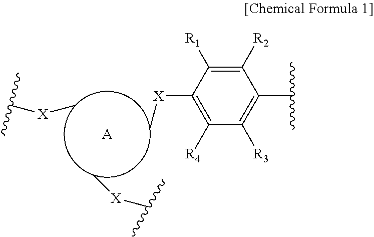
In Chemical Formula 1, A is a mono- or polycyclic ring compound,
—X— is a divalent linking group, and
R¹ to R⁴ are independently selected from —H, —COOM, —SM, —SO₂M, —SO₃M, —PO₃M, or —PO₄M, where R¹ to R⁴ are not simultaneously —H, and M is Li, Li₂, or Li₃.

2. The solid electrolyte according to claim 1, wherein —X— in Chemical Formula 1 is selected from the group consisting of a direct bond, —NH—, —CH—NH—, —NH—C(═O)—, —CH—CH—NH—, —OC(═O)—NH—, —CH2-C(═O)O—NH—, —B(—O—)₂, and —C(═O) NH—N═CH—.

3. The solid electrolyte according to claim 1, wherein Chemical Formula 1 is represented by the following Chemical Formula 1-1. 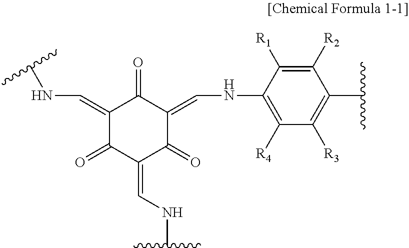
In Chemical Formula 1-1, R¹ to R⁴ are the same as defined in Chemical Formula 1.

4. The solid electrolyte according to claim 1, wherein the covalent organic framework is a polygonal structure having a repeating unit of Chemical Formula 1 on one side and a pore formed inside.

5. The solid electrolyte according to claim 4, wherein the pores of the covalent organic framework have a diameter of 1.0 to 8.0 nm.

6. The solid electrolyte according to claim 1, wherein the covalent organic framework includes a repeating unit represented by the following Chemical Formula 2. 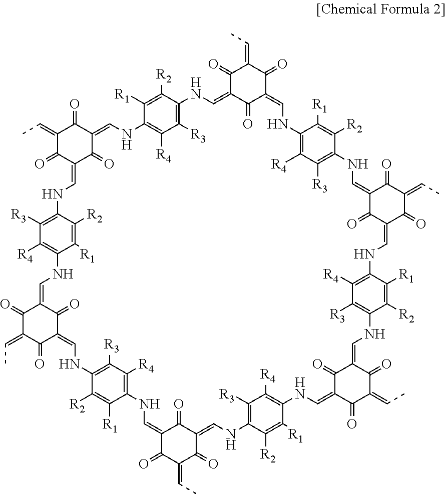
In Chemical Formula 2, R¹ to R⁴ are independently selected from —H, —COOM, —SM, —SO₂M, —SO₃M, —PO₃M, or —PO₄M, where R¹ to R⁴ are not simultaneously —H, and M is Li, Li₂, or Li₃.

7. The solid electrolyte according to claim 1, wherein the crosslinkable monomer is selected from the group consisting of a polyalkylene oxide-based polyfunctional monomer, 11-azido-3,6,9-trioxaundecan-1-amine, acrylonitrile, methacrylamide, and a combination of two or more thereof, and
the polyalkylene oxide-based polyfunctional monomer includes two or more reactive functional groups selected from the group consisting of an acrylate group, a methacrylate group, a vinyl group, a thiol group, an epoxy group, an isocyanate group, a silanol group, a halogen, a carboxyl group, a hydroxyl group, and an amine group.

8. The solid electrolyte according to claim 7, wherein the polyalkylene oxide-based polyfunctional monomer has a number average molecular weight of 100 to 10,000 g/mol.

9. The solid electrolyte according to claim 1, wherein the crosslinked polymer is included in an amount of 1 to 100 parts by weight based on 100 parts by weight of the covalent organic framework.

10. The solid electrolyte according to claim 1, wherein the thickness of the solid electrolyte is 0.1 to 100 μm.

11. The solid electrolyte according to claim 1, wherein the lithium ion conductivity of the solid electrolyte is 6.0×10⁻⁵ S/cm or more.

12. An all-solid-state battery comprising the solid electrolyte according to claim 1.

13. A method for manufacturing a solid electrolyte, comprising the steps of:
(S1) applying pressure to a slurry composition for manufacturing a solid electrolyte, the composition comprising (i) a covalent organic framework containing a repeating unit represented by the following Chemical Formula 1 and (ii) a crosslinkable monomer selected from the group consisting of a polyalkylene oxide-based polyfunctional monomer, 11-azido-3,6,9-trioxaundecan-1-amine, acrylonitrile, methacrylamide, and a combination of two or more thereof; and
(S2) manufacturing a crosslinked polymer by polymerizing the solid electrolyte slurry composition.

14. The method for manufacturing a solid electrolyte according to claim 13, wherein in step (S1), a pressure of 5 to 250 MPa is applied.

15. A slurry composition for manufacturing a solid electrolyte, comprising a covalent organic framework containing a repeating unit represented by the following Chemical Formula 1, and a crosslinkable monomer selected from the group consisting of a polyalkylene oxide-based polyfunctional monomer, 11-azido-3,6,9-trioxaundecan-1-amine, acrylonitrile, methacrylamide, and a combination of two or more thereof. 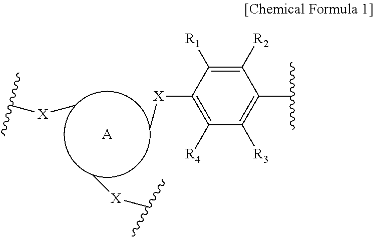
In Chemical Formula 1, A is a mono- or polycyclic ring compound,
—X— is a divalent linking group, and
R¹ to R⁴ are independently selected from —H, —COOM, —SM, —SO₂M, —SO₃M, —PO₃M, or —PO₄M, where R¹ to R⁴ are not simultaneously —H, and Mis Li, Li₂, or Li₃.
